(19) United States
(12) Patent Application Publication
(10) Pub. No.: US 2017/0261185 A1
(43) Pub. Date: Sep. 14, 2017

(54) ASSEMBLY SYSTEM, ATTACHMENT DEVICE AND METHOD FOR ATTACHING A LAMP AND LAMP WITH AN ATTACHMENT DEVICE

(71) Applicant: Hoffmeister Leuchten GmbH, Schalksmuhle (DE)

(72) Inventor: Oliver Hoffmeister, Lüdenscheid (DE)

(21) Appl. No.: 15/510,985

(22) PCT Filed: Sep. 15, 2015
(86) PCT No.: PCT/EP2015/071126

§ 371 Date: Mar. 13, 2017

(30) Foreign Application Priority Data
Sep. 15, 2014 (DE) 102014013658.2

(51) Int. Cl. F21V 17/02; F21V 23/06; F21V 29/74; F21V 21/088

(52) U.S. Cl. CPC F21V 17/02; F21V 21/088; F21V 23/06; F21V 29/74

(57) ABSTRACT

Assembly system for attaching a lamp, in particular for attaching an electric cabinet lamp to an electric cabinet, comprising a support structure for the attachment of a lamp, and an attachment device for attaching a lamp to the support structure, wherein the support structure comprises a plurality of shaped elements, wherein the attachment device comprises at least two attaching elements for the connection with at least two shaped elements of the support structure, and wherein at least one of the attaching elements is movable relative to the other attaching element for the tool-free engagement of one of the shaped elements.

The present invention refers to an assembly system, an attachment device and a method for attaching a lamp as well as a lamp, in particular for the attachment in an electric cabinet.

The prior art in document EP 1 670 107 B1 discloses a cabinet for accommodating and arranging electronic components, said cabinet comprising vertical and horizontal metal profile strips, to which the housing of a light is attached. According to this prior art document, the attachment of the housing of the light may be realized by one or more hooks or latching protrusions, which project from side faces of the housing and which can be inserted in mounting holes formed in the profile strips. Thus, the hooks or latching protrusions may be inserted in said mounting holes and may afterwards be displaced into a hoiding position. However, in case of an according attachment, there remains the risk of an unintended detachment of the lamp, in particular, in case of a horizontal arrangement a self-acting detachment may not be excluded.

Furthermore, document EP 1 670 107 B1 refers to the possibility of attaching a lamp via screws, which may be fastened to the profile strips. However, this requires several handling steps, thereby increasing the effort for attaching the lamp to the respective cabinet. Also, in this case the detachment of the lamp requires several handling steps.

In view of the above, it has been the objective of the present invention to provide an assembly system for attaching a lamp, which allows a secure attachment of a lamp with reduced handling effort. It has also been the objective to provide an attachment device and a method for attaching a lamp as well as a lamp with an according attachment device.

With respect to the assembly system, said objective has been solved by the subject matter of claim 1. As regards the attachment device, the objective has been solved by the features of claim 9. A lamp with an according attachment device is subject to claim 10 and an according method is subject to claim 11.

In accordance with the present invention, an assembly system for attaching a lamp, in particular for attaching an electric cabinet lamp to an electric cabinet, comprises a support structure for the attachment of a lamp, and an attachment device for attaching a lamp to the support structure, wherein the support structure comprises a plurality of shaped elements, wherein the attachment device comprises at least two attaching elements for the connection with at least two shaped elements of the support structure, and wherein at least one of the attaching elements is movable relative to the other attaching element for the tool-free engagement of one of the shaped elements.

Accordingly, the support structure is configured as a structure, to which a lamp, in particular the housing of a lamp may be attached. On the other hand, the attachment device may establish a connection between a lamp, in particular the housing of a lamp, and the support structure. Since the attachment device is provided with at least two attaching elements a reliable connection with the support structure may be realized, particularly without the risk of undesired rotation or tilt of the lamp. This is particularly true when taking into consideration that the at least two attaching elements may be spaced relatively to each other.

Moreover, by providing a movable arrangement of at least one of the attaching elements relative to the other attaching elements, at least one of the attaching elements may be engaged tool-free with one of the shaped elements. This ensures that at least one of the attaching elements may be connected with one of the shaped elements with reduced handling effort. At the same time an improved connection security may thereby be achieved.

In other words, the engagement of at least one of the attaching elements may be realized by a relative movement between the at least two attaching elements. Therefore also the detachment of at least one of the attaching elements would require a relative movement between the attaching elements. Such relative movement for the detachment of the attaching elements is, though, less likely to occur unintentionally. Therefore, the connection security may be improved while ensuring a simplified attachment procedure. Likewise, an intended detachment is simplified, as it merely requires a relative movement of the attaching elements, whereby at least one of the attaching elements may be disengaged.

According to a preferred embodiment of the assembly system, the attaching elements are configured for the establishment of a positive and/or non-positive connection with the shaped elements. Thereby, a particularly secure connection between the attachment device and the support structure may be realized, which thus leads to an improved attachment security of the lamp. In particular, at least one of the attaching elements may comprise an engaging member, which is preferably configured for a behind engagement of the shaped elements. Preferably both attaching elements may comprise engaging members, wherein in this case it may be advantageous that the engaging members have opposed engaging directions. More particularly, the at least one engaging member may preferably have a hook-like shape.

Alternatively, one of the attaching elements may comprise a fastening tongue, wherein said fastening tongue is preferably provided with an opening for a fastening member. An according fastening tongue is easy to manufacture and provides a reliable connection with the support structure of the assembly system.

According to a further preferred embodiment of the assembly system, at least one attaching element is movable relative to the other attaching element between an engaging and a release position, wherein the relative movement is preferably limited in both directions. Thereby the procedure for attaching a lamp to the support structure may be simplified and the risk of operating errors may be reduced. More preferably, both attaching elements may be movable relative to a lamp casing. In the latter case it is preferred that both attaching elements comprise an engaging member configured for a behind engagement of the respective shaped elements.

According to yet a further preferred embodiment of the assembly system, the attachment device comprises a guiding structure for guiding the relative movement between the attaching elements. The handling of the assembly system during an attachment procedure is thereby further simplified. Preferably, the guiding structure is connected to or provided on a lamp casing, whereby an easy connection between the attachment device and the lamp casing may be realized.

Preferably, the guiding structure comprises at least one guiding groove for guiding at least one attaching element, wherein the guiding structure preferably comprises a plurality of guiding grooves, which are more preferably oriented at an angle relative to each other. By arranging a plurality of guiding grooves, different attachment positions or attachment orientations of the respective lamp may be chosen, thereby increasing the flexibility of the assembly system. The attaching elements may be arranged detachable from the guiding structure. By arranging the attaching elements detachably from the guiding structure, the attaching elements may on the one hand he exchanged in case of failure, but also the use of the attaching elements for different attaching positions and/or orientations may be implemented. By movably arranging both attaching elements relative to the guiding structure, the handling effort during an assembly procedure may be further reduced.

According to yet another preferred embodiment of the assembly system, the attachment device comprises at least one securing element for forcing at least one attaching element into the engaging position and/or maintaining the attaching element in the engaging position. Preferably both attaching elements are forced into and/or maintained in the engaging position by a securing element. More preferably, the securing element is supported relative to the guiding structure. By providing a securing element according to any one of the above features, the risk of an unintended detachment of the lamp is minimized, as a detaching movement of the respective attaching element is either restricted or an according detaching movement would at least require to overcome a force provided by the securing element.

Such a securing element may for example be provided in the form of a spring. The securing spring may preferably be pretensioned in order to urge the attaching element into the engaging position. The pretension of the spring may be configured such that an urging force is also exerted on the respective attaching element in its engaging position or in a position with maximum distance between the attaching elements.

According to yet a further embodiment of the assembly system, the attachment device comprises at least one support member for insertion into at least one shaped element of the support structure for restricting the movement of the guiding structure at least in a moving orientation of the at least one attaching element. Thereby it may be ensured that an urging force exerted by the securing element on the attaching element does not lead to a displacement of the lamp casing or the guiding element relative to the support structure. Thus, during the procedure of attaching a lamp to a support structure, a displacement of the guiding structure or the lamp casing in the moving direction of the at least one attaching element is avoided, and the urging force exerted by the securing element may reliably force the at least one attaching element into the engaging position and/or maintain the attaching element in the engaging position, particularly in case the attaching element is in engagement with one of the shaped elements.

According to yet a further embodiment of the assembly system, the attachment device comprises at least one positioning member for insertion into at least one shaped element of the support structure for positioning the attachment device relative to the support structure prior to the engagement of at least one attaching element. It is thereby simplified to arrange the attachment device in a position, in which the at least one attaching element may be moved relative to the other attaching element in order to engage the respective shaped element in a tool-free manner. The insertion of the at least one positioning member into at least one shaped element may require that the at least one attaching element is moved into a release position. After the positioning element has been fully inserted into the respective shaped element, the attaching element may be moved from the release position to the engaging position. In a particularly advantageous embodiment, the positioning member is identical with the support member. Thereby, the functionalities of the support member and the positioning member may be provided by one and the same component.

According to yet a further preferred embodiment of the assembly system, the support structure is fixedly arranged, preferably fixedly arranged on or inside a cabinet, in particular inside an electric cabinet, wherein the support structure is preferably formed as a shaped profile and/or wherein the shaped elements of the support structure are preferably formed by a hole pattern, wherein the hole pattern preferably comprises slot holes and round holes, which preferably alternate along a hole pattern line. Preferably, the shaped profile comprises a plurality of hole pattern lines, more preferably formed on hole pattern portions being arranged at a distance to each other and/or at an angle relative to each other. The attaching flexibility may thereby be increased while at the same time a high degree of connection security between the attachment device and the support structure may be maintained.

In a further preferred embodiment, the attaching elements are configured to be connected with the long holes and/or the round holes, wherein the engaging members are preferably configured to engage the long holes, wherein the support member and/or the positioning member is preferably configured to be inserted into a round hole. In particular, an engaging member may be inserted into a long hole and in the inserted position be moved between a release position arid an engaging position. A shaped element in the form of a long hole does provide sufficient moving space for the engaging member to move between the release and the engaging position.

At the same time, the positioning member may be configured to be inserted into a round hole, thereby restricting a relative movement between the attachment device and the support structure. Alternatively, in case the attaching element is formed as a fastening tongue, a fastening member such as a fastening screw may be inserted through an opening of the fastening tongue and screwed into a round hole of the support structure. An according screwing process may be accompanied by thread cutting inside the round hole.

According to a further aspect of the present invention, an attachment device for attaching a lamp, in particular for attaching an electric cabinet lamp to an electric cabinet, comprises at least two attaching elements for the connection With at least two shaped elements of a support structure for the attachment of a lamp, wherein at least one of the attaching elements is movable relative to the other attaching element for a tool-free engagement of one of the shaped elements, and wherein the relative movement between the attaching elements is guided by a guiding structure. An according attachment device may be employed in an assembly system described above, thereby allowing a simplified handling during the attachment of a lamp and at the same time ensuring an increased connection security between the lamp and a respective support structure, to which the lamp is to be attached.

The attachment device for attaching a lamp may comprise any further feature described in connection with the embodiments of the assembly system for attaching a lamp.

According to yet a further aspect of the invention, a lamp, in particular for the attachment in an electric cabinet, comprises the above-described attachment device.

Further embodiments of the present invention result from combinations of the features disclosed in the claims, the specification and the drawings. Embodiments of the present invention will in the following be described with reference to the Figures.

### BRIEF DESCRIPTION OF THE DRAWINGS

FIG. 1 is a perspective view of a part of an assembly system according to an embodiment of the present invention;

FIG. 2 is a perspective view of another part of an assembly system according to an embodiment of the present invention;

FIG. 3 is a perspective view of a support structure according to an embodiment of the present invention;

FIG. 4 is a perspective view of a lamp with an attachment device according to an embodiment of the present invention;

FIG. 5 is a perspective view of a guiding structure according to an embodiment of the present invention.

FIG. 6 is an exploded view of a lamp with an attachment device according to an embodiment of the present invention;

FIG. 7 is an upper perspective view of parts of an attachment device according to an embodiment of the present invention;

FIG. 8 is a lower perspective view of parts of an attachment device according to an embodiment of the present invention;

FIG. 9 is an exploded view of FIG. 7;

FIG. 10 is a perspective view of an attachment device according to an embodiment of the present invention with the attaching element not introduced into the guiding structure;

FIG. 11 is a perspective view of an attachment device according to an embodiment of the present invention with the attaching element introduced into the guiding structure;

FIG. 12 is a perspective cross-sectional view of an attachment device according to an embodiment of the present invention;

FIG. 13 is a first cross-sectional view of an attachment device according to an embodiment of the present invention; and

FIG. 14 is a second cross-sectional view of an attachment device according to an embodiment of the present invention.

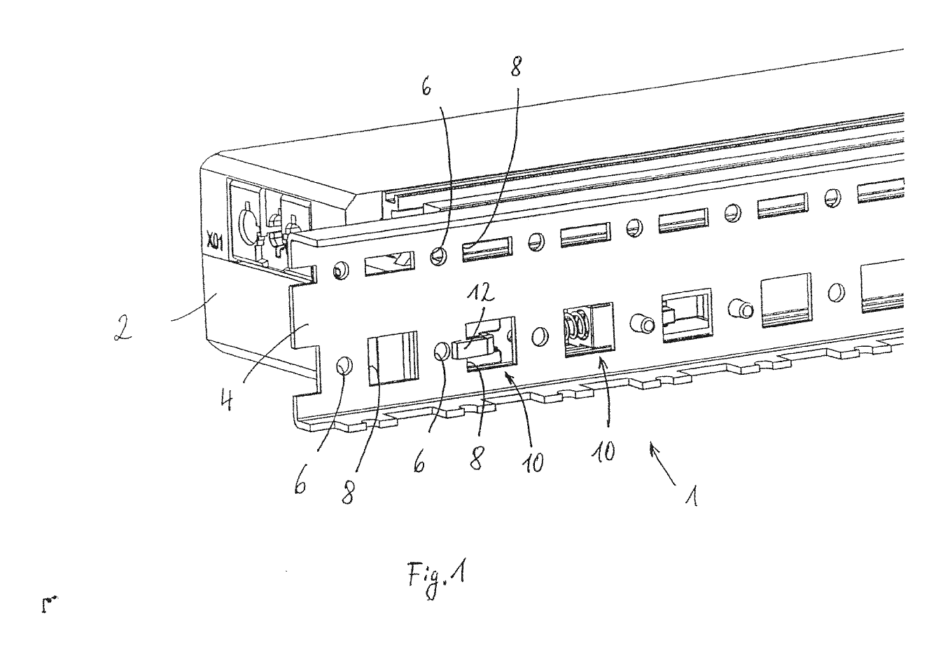

FIG. 1 is a perspective view showing an assembly system 1 for attaching a lamp 2, in particular for attaching an electric cabinet lamp 2 to an electric cabinet (not shown). The assembly system 1 comprises a support structure 4 for the attachment of a lamp 2. The support structure 2 comprises a plurality of shaped elements 6 and 8. The shaped elements 6 may be formed as round holes and the shaped elements 8 may be formed as long holes or slot holes.

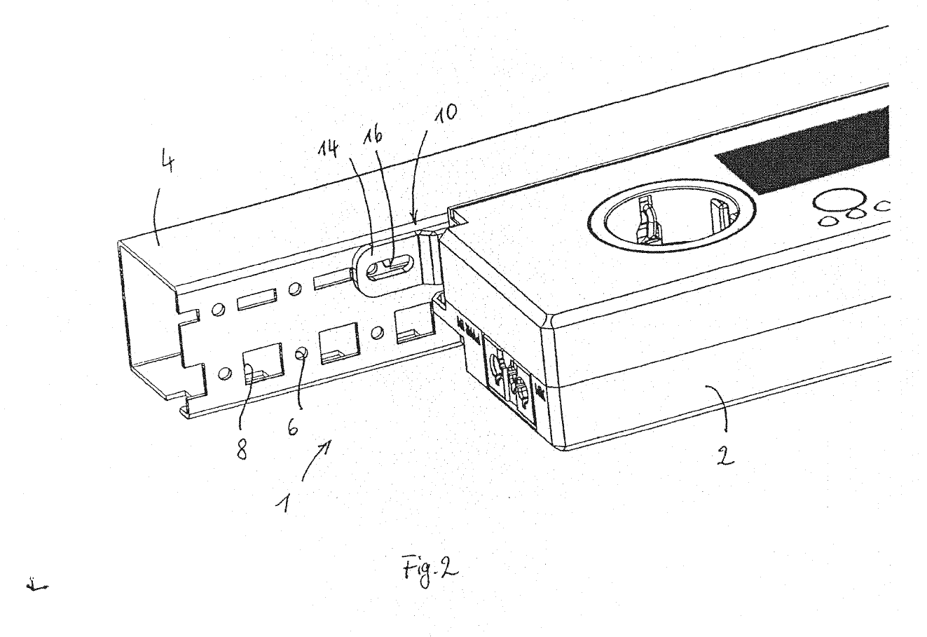

As may further be seen in FIGS. 1 and 2, the assembly system 1 comprises an attachment device 10 for attaching a lamp 2 to the support structure 4. The attachment device 10 comprises two attaching elements 12 and 14 for the connection with at least two shaped elements 6 and 8 of the support structure 4. Attaching element 14 is shown in FIG. 2, which is a further perspective view of an assembly system according to an embodiment of the present invention. In the present case, the attaching element 12 is movable relative to the attaching element 14 for the tool-free engagement of one of the shaped elements 8.

Both of the attaching elements 12 and 14 are configured for the establishment of a positive and/or non-positive connection with the shaped elements 6 and/or 8. The attaching element 12 comprises an engaging member 58, which is configured for a behind engagement of the shaped element 8. More particularly, the engaging member 58 may have a hook-like shape for the be-hind engagement of the elongated hole 8. Therefore, in case the engaging member 58 with its hook-like shape engages the shaped element 8, a movement of the attachment device 10 in a direction away from the support structure 4 is restricted.

As may further be comprehended from FIG. 2, the attaching element 14 comprises a fastening tongue, which is preferably provided with an opening 16 for a fastening member (not shown). Thus, the fastening tongue 14 may be connected to the support structure 4 via a screw, a bolt or the like, which engages with one of the shaped elements 6 or 8, particularly with a round hole 6.

Preferably, the opening 16 for a fastening member may be formed in an elongated shape, thereby allowing the fastening tongue 14 and therewith the attachment device 10 as well as the lamp casing to be adjusted in its position relative to the supporting structure 4. An according adjustment may be conducted while a fastening member is already in engagement with the corresponding shaped element 6, however not entirely fastened.

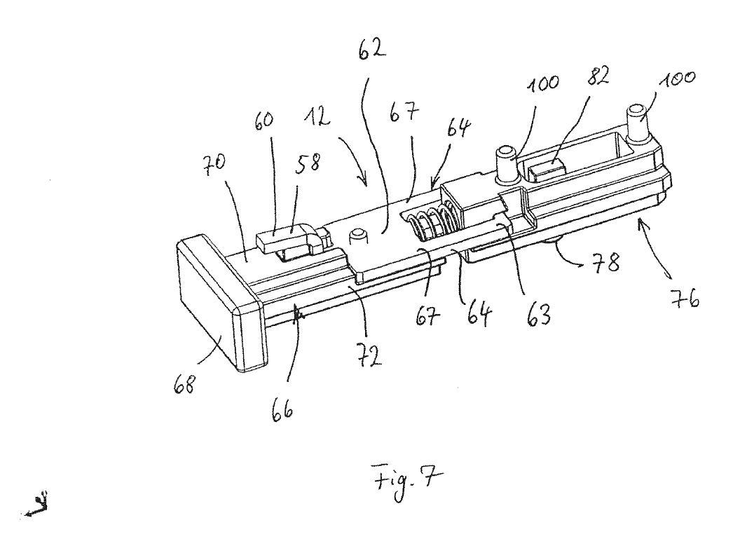

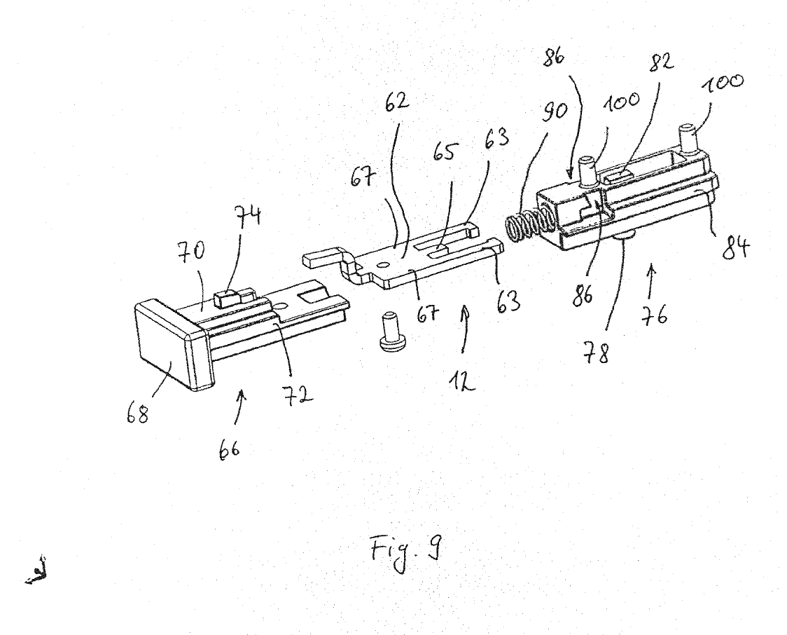

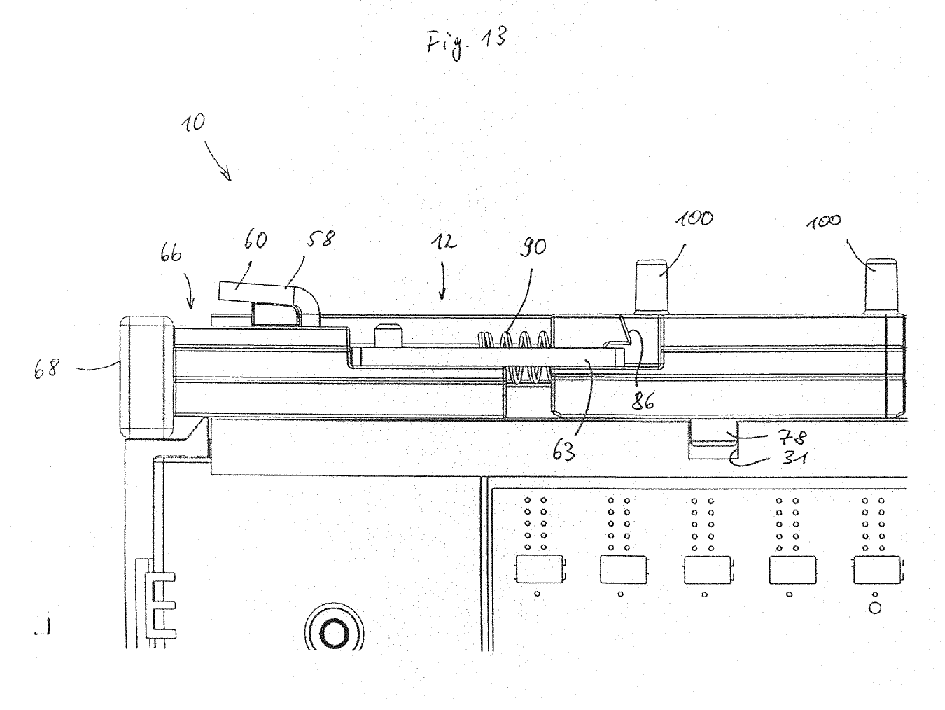

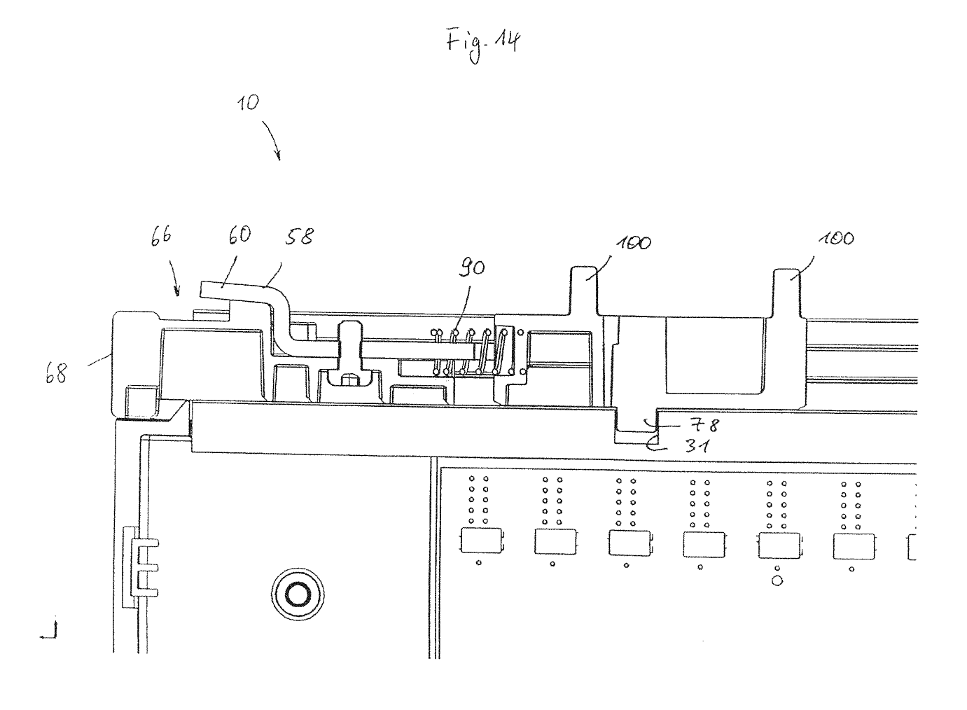

It is also possible that the attachment device 10 for attaching a lamp to the support structure 4 comprises two attaching elements 12, which comprise an engaging member, in particular with a hook-like shape as shown in FIGS. 1 and 7 to 14. In this case, the fastening tongue 14 shown in FIG. 2 would be replaced by an attaching element 12 as shown in FIGS. 1 and 7 to 14. Accordingly, the attachment device 10 would be provided with two engaging members 58 as shown in FIGS. 7 to 14. Said two engaging members 58 would be arranged at two separate positions spaced from each other. An according configuration of the attachment device would allow establishing a connection between the attachment device 10 and the support structure 4 entirely free of tools. The handling effort may be thereby further reduced.

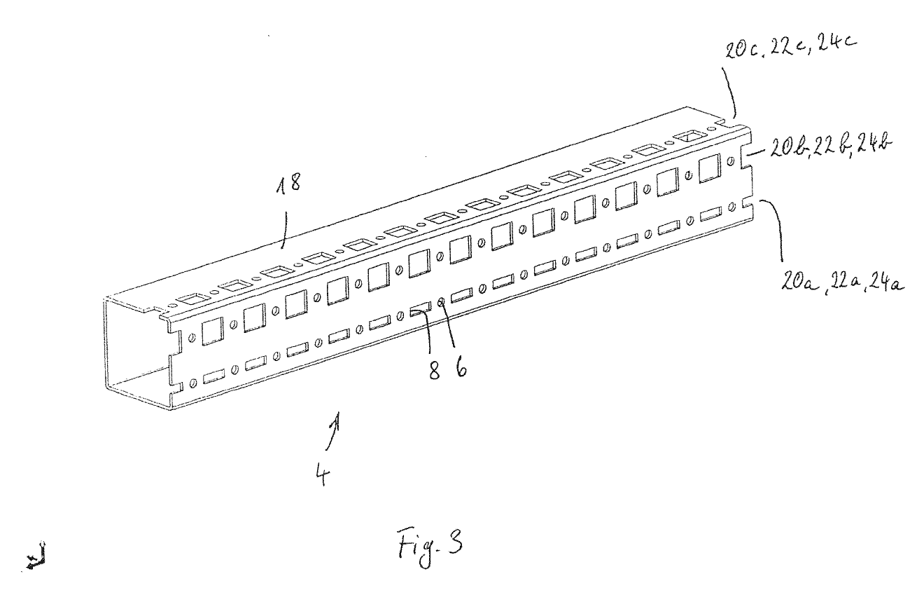

FIG. 3 shows a perspective view of a support structure 4 according to an embodiment of the present invention. As already mentioned above, the support structure 4 may comprise a plurality of shaped elements 6 and 8. An according support structure 4 may be fixedly arranged, particularly fixedly arranged on or inside an electric cabinet not shown here. The support structure 4 may be arranged horizontally or vertically and/or fixed in different orientations. Preferably, the support structure is formed as a shaped profile. Said shaped profile may have a hollow body 18.

Furthermore, the shaped elements 6 and 8 of the support structure 4 may be formed by a hole pattern 20a, 20b, 20c, Said hole pattern 20a, 20b, 20c may be provided in the hollow body 18. The hole pattern 20a, 20b, 20c may comprise slot holes 8 and round holes 6, wherein the slot holes 8 and the round holes 6 preferably alternate along a hole pattern line 22a, 22b or 22c. Thus, the shaped profile 4 may comprise a plurality of hole pattern lines 22a, 22b and 22c, which are preferably formed on hole pattern portions 24a, 24b and 24c. Said hole pattern portions 24a, 24b and 24c may be arranged at a distance to each other and/or at an angle relative to each other, whereby the attaching flexibility between the support structure 4 and the attachment device 10 may be increased.

Furthermore, the exact shape of the shaped elements 6 and 8 may vary between different hole pattern lines 22a, 22b and 22c. It may be advantageous that all round holes 6 and all slot holes 8 within a single hole pattern line 22a, 22b and 22c have the same shape, wherein the shapes of the shaped elements 6 and 8 differ between the different hole pattern) lines 22a, 22b and 22c.

For example, the width of the slot holes 8 may be greater in the hole pattern line 22b than in the hole pattern line 22a.

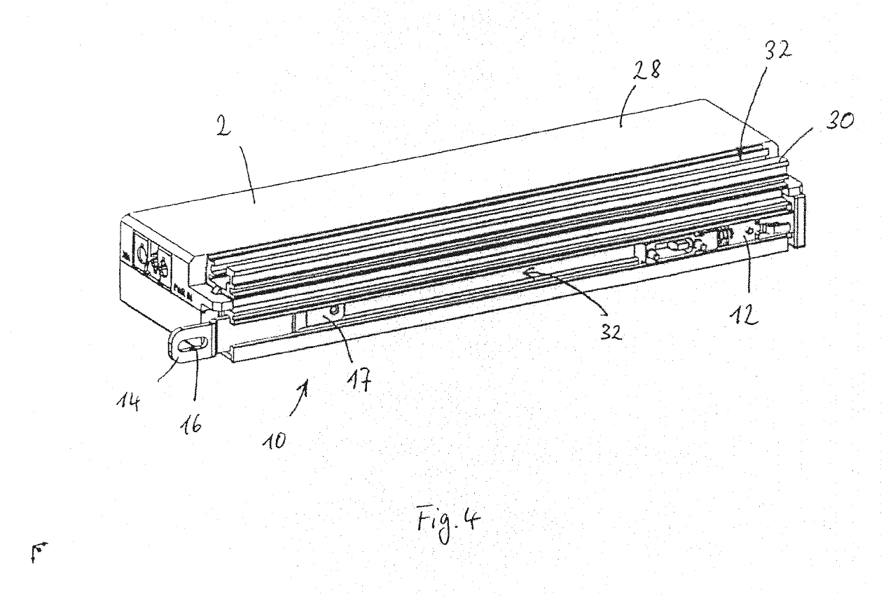

FIG. 4 is a perspective view of an electric cabinet lamp 2 with an attachment device 10 according to an embodiment of the present invention. As outlined above, the attachment device 10 is equipped with an attaching element 12 and a further attaching element 14, wherein the attaching element 12, is configured for behind engagement of the shaped elements 8, particularly formed as an engaging member. Contrary to this, attaching element 14 is formed as a fastening tongue, which comprises an opening 16 for a fastening member (not shown). The attaching element 12 is movable relative to the other attaching element 14 for the tool-free engagement of one of the shaped elements 8.

In this regard, it is advantageous when the attaching element 12 is movable relative to the other attaching element 14 between an engaging and a release position. That is, by moving the attaching element 12 towards the attaching element 14, the attaching element 12 will arrive at its release position, whereas when moving the attaching element 12 in a direction opposite to the attaching element 14, the attaching element 12 will arrive at its engaging position. Preferably, the relative movement between the attaching element 12 and the attaching element 14 is limited in both directions, thereby avoiding a false operation of the attachment device 10.

As may further be seen from FIG. 4, the attachment device 10 is fixed to the lamp 2, in particular to the lamp casing 28. Accordingly, the attaching element 12 is also movable relative to the lamp 2 and/or the lamp casing 28. The attachment device 10 may be provided with two attaching elements 12, which are movable relative to each other and both also movable relative to the lamp 2 and/or the lamp casing 28. In this case, the fastening element 14 with a fastening tongue is replaced by an attaching element 12, which is provided as with the engaging member, preferably with a hook-like shape, as also shown in FIGS. 7 to 14. In this case, the attachment device 10 would be equipped with movable attaching elements 12 at both attaching positions spaced apart from each other. In this case, it may be advantageous if both engaging members of the two attaching elements 12 have opposed engaging directions, whereby an improved connection security may be achieved.

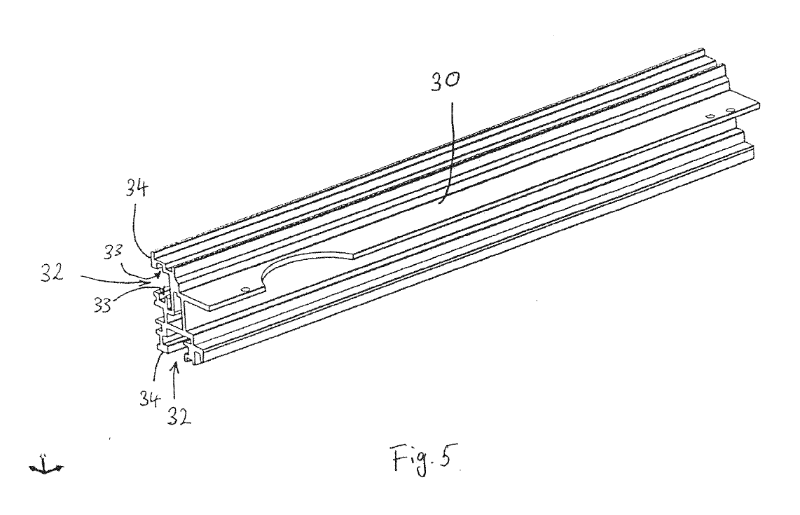

Furthermore, it may be comprehended from FIG. 4 that the attachment device comprises a guiding structure 30 for guiding the relative movement between the attaching elements 12 and 14. FIG. 5 is a perspective view of a guiding structure 30 according to an embodiment of the present invention.

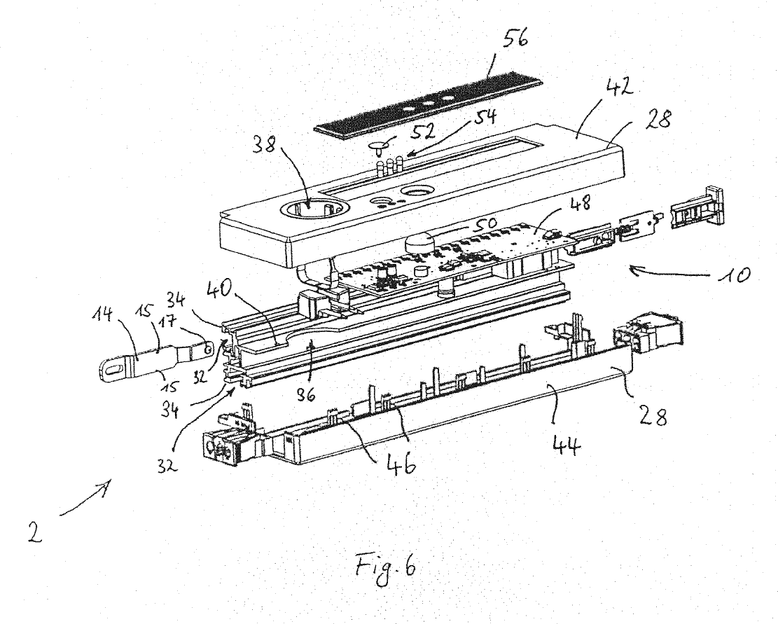

The guiding structure 30 is preferably connected to or provided on a lamp casing 28. The guiding structure 30, may form part of the lamp casing 28 or provide connection functionality for components of the casing 28. This will be described below with reference to FIG. 6.

The guiding structure 30 comprises at least one guiding groove 32 for guiding at least one attaching element 12 or 14. Thus, the attaching elements 12 and 14 may be inserted in the guiding grooves 32 of the guiding structure 30, in order to be fixedly arranged or movably arranged therein. In order to prevent the attaching elements 12 and/or 14 to be disengaged from the guiding grooves 32 in a direction perpendicular to the guiding direction, the guiding grooves 32 may comprise holding recesses 33 in their side faces. The attaching elements 12 and 14 may have retaining portions, which are formed to correspond with the holding recesses 33. Thereby it may be ensured that the attaching elements 12 and/or 14 are merely guided in the guiding grooves 32 along one single orientation.

Preferably, the guiding structure 30 comprises a plurality of guiding grooves 32, for example two guiding grooves 32, which may be spaced apart from each other and/or oriented at an angle relative to each other. In this case, it would be advantageous if the attaching elements 12 or 14 would be detachable from the guiding structure 30, in order to be inserted into different guiding grooves 32 of the guiding structure 30. Thereby, the orientation of the lamp 2 in its attached position may be changed and the flexibility of the attachment device 10 may be improved. According to a preferred embodiment, both attaching elements may comprise engaging members 58 and both may also be movable relative to the guiding structure 30.

The guiding structure 30 may be an aluminum profile or also formed from any other suitable material, for example a sufficiently rigid plastics material. However, for the sake of heat conduction and superior rigidity characteristics, a metal material is preferred for the guiding structure. Furthermore, in order to provide an improved heat transfer, the guiding structure 30 may be provided with heat transfer faces 34 adjacent to the guiding grooves 32. The heat transfer faces 34 may transfer heat, developed during the operation of the lamp, in particular its light emitting source, to the support structure 4 and/or the environment. In particular, the, heat transfer faces 34 may contact the support structure 4 in a position, in which the attachment device 10 is connected with the shaped elements 6 and 8 of the support structure 4. In case the support structure 4 as well as the guiding structure 30 are both made of a metal material, the heat transfer from the guiding structure 30 to the support structure 4 may take place in a more efficient way.

FIG. 6 is an exploded view of a lamp 2 with an attachment device 10 according to an embodiment of the present invention. The attachment device 10 comprises attaching elements 12 and 14, as outlined above with reference to FIGS. 1, 2 and 4. Furthermore, the attachment device 10 comprises the guiding structure 30 in the form of a profile. The guiding structure 30 comprises two separate guiding grooves 32. Adjacent to the guiding grooves 32, the guiding structure 30 may be provided with heat transfer faces 34. Furthermore, the guiding structure 30 may be provided with a recess 36 for receiving an electrical socket 38 being provided in the casing 28 of a lamp. At the same time, the electrical socket 38 may be fixedly attached to the guiding structure 30 via a screwed connection. For the establishment of a screwed connection, a through-hole 40 may be provided in the guiding structure 30.

Moreover, the electric cabinet lamp 2 is equipped with a casing 28. The casing 28 may comprise an upper casing member 42 and a lower casing member 44. The guiding structure 30 may form part of the casing 28. The upper and lower casing members 42 and 44 may be connected tool-free via latching elements 46. In the connected position of the upper casing member 42 and the lower casing member 44, the upper and lower casing members 42 and 44 engage the guiding structure 30 in order to establish a form-fit between the guiding structure 30 and the upper and lower casing members 42 and 44. Therewith, a simplified assembly of the lamp casing 28 may be achieved.

In the assembled arrangement of the casing 28, the upper casing member 42 and the lower casing member 44 embrace the guiding structure 30, in order to define an enclosed volume inside the lamp casing 28. Within the casing 28, there may be arranged a circuit board, in particular an LED circuit board 48. Furthermore, there may be provided a motion sensor 50, an operating element 52, display elements 54 as well as a lens 56, each of which is provided in the upper casing member 42.

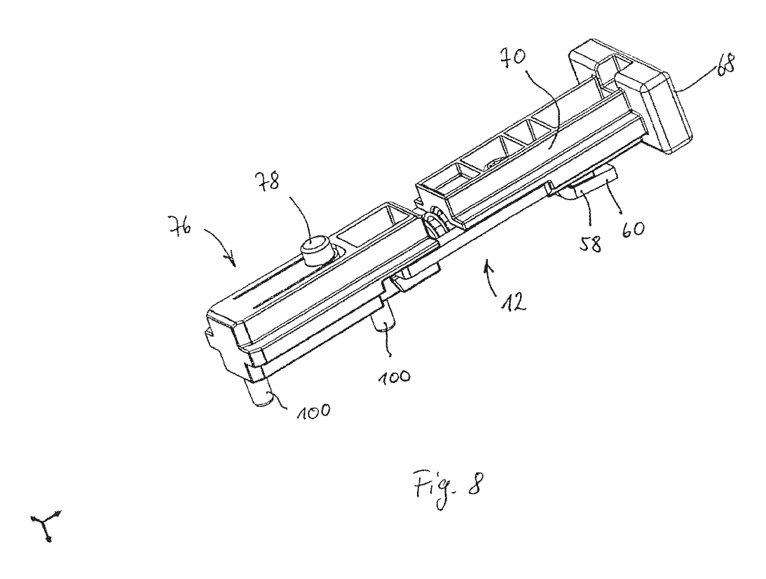

In the following, the attaching element 12 and its corresponding components will be described with reference to FIGS. 7 to 14. FIGS. 7 and 8 are upper and lower perspective views of parts of an attachment device 10 according to an embodiment of the present invention, in particular showing an attaching element 12 and its peripheral components.

The attaching element 12 comprises an engaging member 58. The engaging member 58 may be formed in a hook-like shape. Furthermore, the engaging member 58 may be provided with an inclined portion 60. The inclined portion 60 may he inclined relative to a base portion 62 of the attaching element 12. The engaging member 58 and the base portion 62 may be integrally formed or attached to each other. The base portion 62 may be configured to be inserted into guiding grooves 32 of the guiding structure 30. More particularly, the base portion 62 of the attaching element 12 may be formed to be inserted into said holding recesses 33 in order to be fixedly guided within the guiding grooves 32 along only one orientation.

Accordingly, the length side portions 67 of the base portion 62 may form retaining portions to be inserted into holding recesses 33 of the guiding grooves 32. Therefore, the distance between the length faces 64 of the base portion 62 may be chosen in accordance with the distance between two opposing holding recesses 33 of one of the guiding grooves 32, such that the base portion 62 may be inserted and held within the holding recesses 33.

By arranging the inclined portion 60 inclined relative to the base portion 62, it may on the one hand be ensured that the engaging member 58 may easily be engaged with a shaped element 8 of the support structure 4. At the same time, the inclined portion ensures that during the engagement movement of the attaching element 12, any remaining distance between the support structure 4 and the attachment device 10, in particular its guiding structure 30, is minimized. By minimizing the distance between the guiding structure 30 and the support structure 4, a discrete contact between these components may be established, whereby an improved heat transfer is ensured.

Furthermore, in the final engaging position of the engaging member 58, also a non-positive connection between the engaging member 58 and the shaped element 8 may be established, thereby reducing the risk that the engaging element 58 is unintentionally moved back into its release position. Thus, non-positive connection may more easily be achieved by providing the inclined portion 60 of the engaging member 58.

As may further be comprehended from FIGS. 7 to 14, an actuating element 66 may be connected to the attaching element 12. The connection between the actuating element 66 and the attaching element 12 may be established via a screwed connection, a rivet, a bolt or the like. The actuating element 66 may comprise an actuating head 68 and an insertion portion 70, which may like-wise be inserted into a guiding groove 32. In particular, the insertion portion 70 may comprise length side portions 72 being aligned with the length side portions 67 of the base portion 62 in order to be insertable into the holding recesses 33 of the guiding grooves 32 together with the base portion 62.

The attaching element 12 may be connected with the actuating element 66 via the insertion portion 70. Moreover, the actuating element 66 may be provided with a supporting protrusion 74, which supports the inclined portion 60 of the attaching element 12, particularly preventing a substantial change of the inclination of the inclined portion 60 in a direction towards the insertion portion 70 of the actuating element 66. The actuating head 68 may be operated by an operator of the attachment device 10 in order to initiate a relative movement between the attaching element 12 and the other attaching element 12 or 14. Therefore, the operability of the attachment device is simplified.

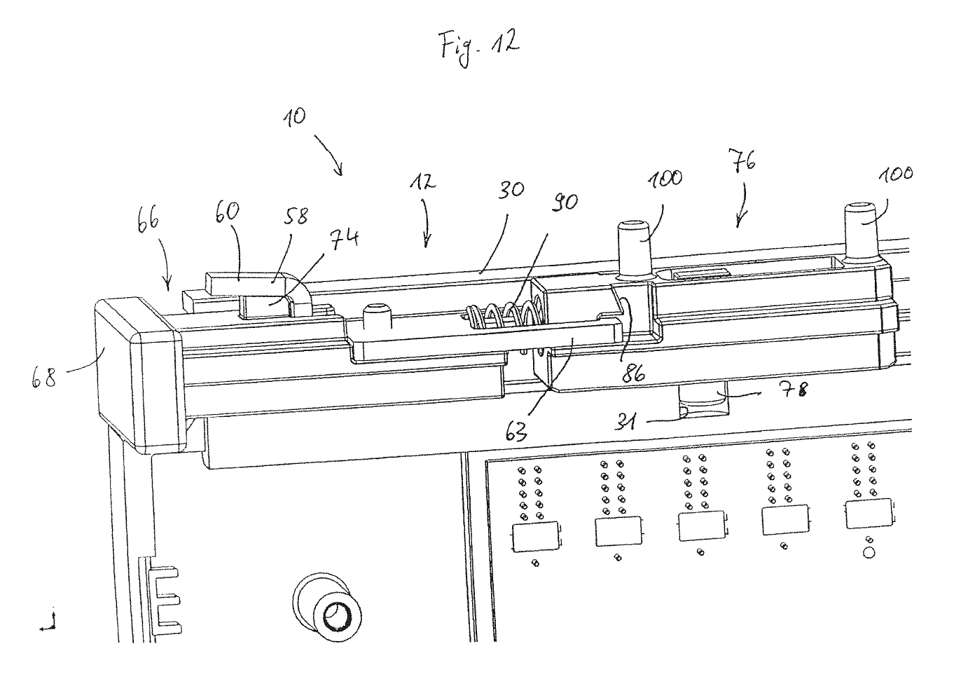

Furthermore, the attachment device 10 may be provided with a fixing element 76 being in operative connection with the attaching element 12. The fixing element 76 may be inserted into a guiding groove 32 of the guiding structure 30 and fixedly positioned within the guiding groove 32 at a predetermined position. For this purpose, the fixing element 76 may be provided with a latching member 78. The latching member 78 is insertable into a latching opening 31 being provided at a predetermined position within the guiding groove 32, as may be comprehended from FIGS. 12 to 14. The latching member 78 is resiliently supported relative to a main body 80 of the fixing element 76. Thereby, the latching member 78 may be pushed into a release position relative to the main body 80. In this position of the latching member 73, the fixing element 76 may be inserted into one of the guiding grooves 32 up to a position where the latching member 78 snaps into the opening 31 inside the guiding groove 32. In order to detach the fixing element 76, the latching member 78 has to be moved out of the opening 31 again, which may be realized by a release actuator 82 being connected or integrally formed with the latching member 78. In other words, a resilient movement of the latching member 78 relative to the main body 80 of the fixing element 76 may be initiated via the release actuator 82.

The fixing element 76 is likewise provided with length side portions 84, which are aligned with the length side portions 67 of the base portion 62 and also with the length side portions 72 of the actuating element 66. Therewith, also the fixing element 76 may be introduced into the holding recesses 33 of the guiding grooves 32.

The connection between the attaching element 12 and the fixing element 76 is established via shaped protrusions 63 of the base portion 62. The shaped protrusions 63 may be engaged with guiding slots 86 at the side faces of the main body 80 of the fixing element 76. The engagement between the protrusions 63 and the slots 86 defines the moving limits of the attaching element 12 relative to the fixing element 76 and therewith also relative to the guiding structure 30. At the engaging and release positions, i.e. the final moving positions in both moving directions of the attaching element 12, the hook-shaped ends of the shaped protrusions 63 abut with laces of the guiding slots 86, thereby restricting further movement of the attaching element 12.

Furthermore, the attachment device 10 comprises at least one securing element 90 for forcing at least one of the attaching elements 12 into the engaging position and/or maintaining the attaching element 12 in the engaging position. Preferably, both attaching elements 12 are forced into or maintained in the engaging position by a securing element 90, in case both attaching 12 elements compose engaging members 58. The securing element 90 may be formed as a spring which exerts a spring force between the fixing element 76 and the attaching element 12. As the fixing element 76 may be fixed relative to the guiding structure 30, the securing element 90 may also be supported relative to the guiding structure 30. On the side of the fixing element 76, the securing element 90 may be introduced into an opening 88 of the main body 80. On the side of the attaching element 12, the securing element 90 may be guided by a guiding protrusion 65. Thereby, the loss of the securing element is prevented.

Furthermore, the attachment device 10 may comprise at least one support member 100 for insertion into at least one shaped element 6 of the support structure 4 for restricting the movement of the guiding structure 30 at least in the moving orientation of the at least one attaching element 12. An according support member 100 may be provided on or integrally connected to the main body 80 of the fixing element 76. Preferably, two support members 100 may be provided, wherein the distance between the two support members may be chosen in accordance with the distance of two shaped elements 6 of the support structure 4. Preferably, the support members 100 are shaped as cylindrical protrusions. Furthermore, the elements 100 may also serve as positioning members for insertion into at least one shaped element 6 of the support structure 4 for positioning the attachment device 10 relative to the support structure 4 prior to the engagement of at least one attaching element 10. Therewith, the orientation and arrangement of the attachment device 10 relative to the support structure 4 is simplified.

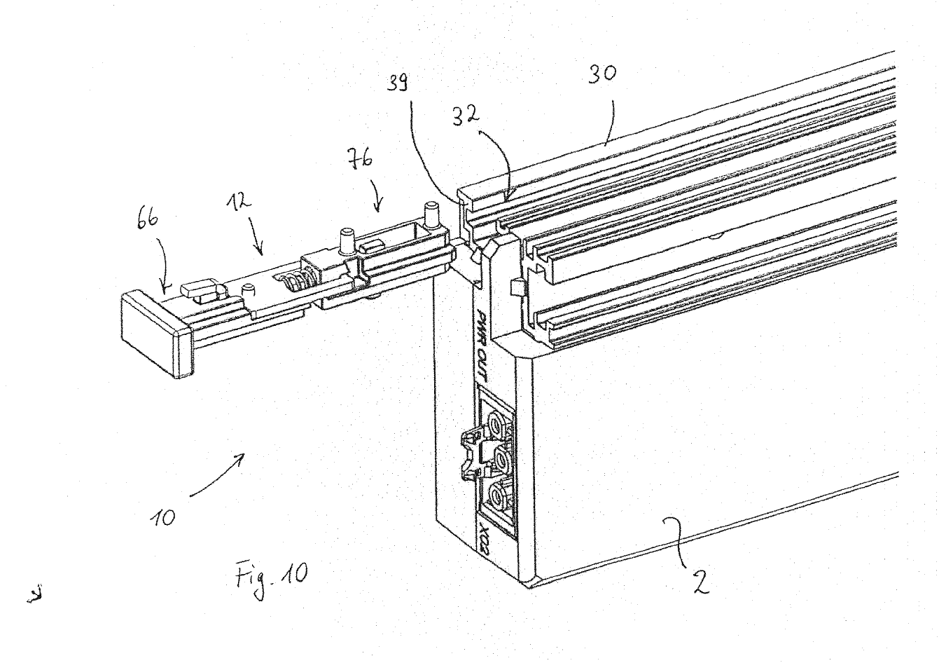

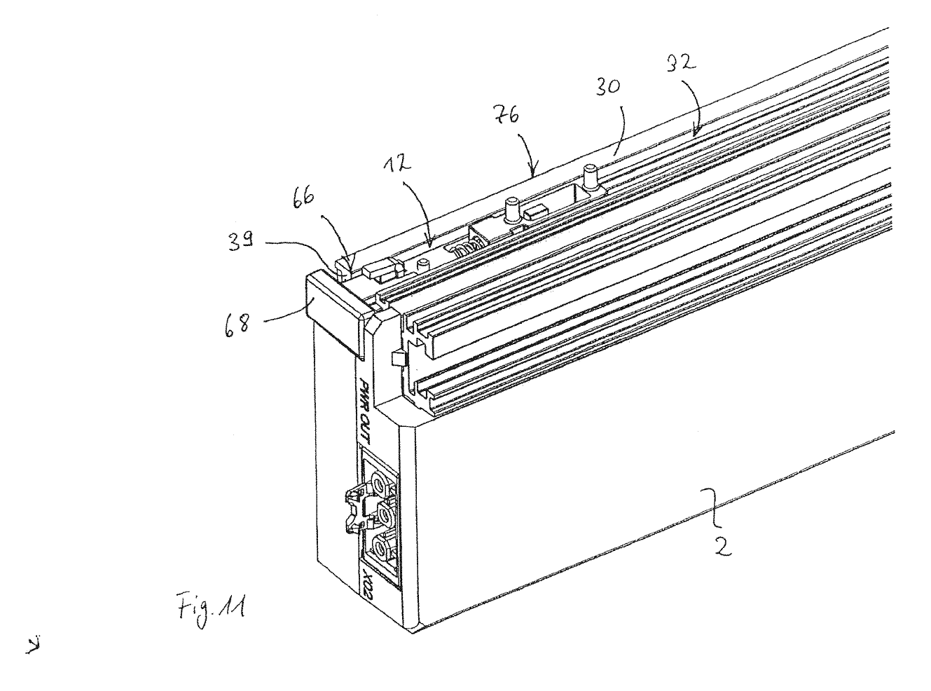

FIG. 10 is a perspective view of an attachment device according to an embodiment of the present invention in a state, where the attaching element 12, the fixing element 76 as well as the actuating element 66 are not inserted into the guiding structure 30. FIG. 11 shows a perspective view of an attachment device 10 according to an embodiment of the invention in a state in which the attaching element 12, the fixing element 76 as well as the actuating element 66 have been introduced into the guiding structure 30, in particular into the respective guiding groove 33.

FIGS. 12 to 14 show further views of an assembled state of the attachment device 10. It is noted that in the assembled state of the attachment device 10 merely the support members 100, the engaging member 58 as well as the support protrusion 74 project out of the length opening of the guiding groove 33, whereas the base portion 62 of the attaching element 12 and the main body 80 of the fixing element 76 remain entirely inside the guiding groove 33. Further to this, the actuating head 68 of the actuating element 66 remains outside the length end of the groove 33, in order to he actuatable by an operator. It is further to be noted that in an engagement position of the respecting engaging member 58, the actuating head 68 may be arranged flush with the outer surface of the casing of lamp 2. In a release position of the respecting engaging member 58, i.e. when the actuating head 68 is pushed towards the inside of groove 32, the actuating head 68 may abut at end face 39 of the guiding structure 30.

As may be comprehended from FIGS. 4 and 6, the attaching element 14, which comprises a fastening tongue, is also configured for insertion into a guiding groove 32 of the guiding structure 30. For this purpose, also the attaching element 14 is provided with length side portions being configured to be inserted into the holding recesses 33 of the respective guiding groove 32. Finally, the attaching element 14 comprises a latching protrusion 17, which may engage a latching opening 31 being provided at a predetermined position within the guiding groove 32. For the detachment of the attaching element 14, the latching protrusion 17 may be bent in order to achieve its disengagement out of the latching opening 31. The attaching element may then be guided out of the respective guiding groove 32.

1. Assembly system for attaching a lamp, in particular for attaching an electric cabinet lamp to an electric cabinet, comprising
a support structure for the attachment of a lamp, and
an attachment device for attaching a lamp to the support structure,
wherein the support structure comprises a plurality of shaped elements,
wherein the attachment device comprises at least two attaching elements for the connection with at least two shaped elements of the support structure, and
wherein at least one of the attaching elements is movable relative to the other attaching element for the tool-free engagement of one of the shaped elements.

2. Assembly system according to claim 1, wherein the attaching elements are configured for the establishment of a positive and/or non-positive connection with the shaped elements, wherein at least one of the attaching elements preferably comprises an engaging member, which is preferably configured for a behind engagement of the shaped elements, wherein preferably both attaching elements comprise engaging members and/or wherein the engaging members have opposed engaging directions, wherein the at least one engaging member preferably has a hook-like shape, wherein preferably one attaching element comprises a fastening tongue, which is preferably provided with an opening for a fastening member.

3. Assembly system according to claim 1, wherein at least one attaching element is movable relative to the other attaching element between an engaging and a release position, wherein the relative movement is preferably limited in both directions, wherein preferably both attaching elements are movable relative to a lamp casing.

4. Assembly system according to claim 1, wherein the attachment device comprises a guiding structure for guiding the relative movement between the attaching elements, wherein the guiding structure is preferably connected to or provided on a lamp casing, wherein the guiding structure preferably comprises at least one guiding groove for guiding at least one attaching element, wherein the guiding structure preferably comprises a plurality of guiding grooves, which are preferably oriented at an angle relative to each other and/or wherein the attaching elements are preferably detachable from the guiding structure, wherein preferably both attaching elements are movable relative to the guiding structure.

5. Assembly system according to claim 1, wherein the attachment device comprises at least one securing element for forcing at least one attaching element into the engaging position and/or maintaining the attaching element in the engaging position, wherein preferably both attaching elements are forced into and/or maintained in the engaging position by a securing element, wherein the securing element is preferably supported relative to the guiding structure.

6. Assembly system according to claim 1, wherein the attachment device comprises at least one support member for insertion into at least one shaped element of the support structure for restricting the movement of the guiding structure at least in a moving orientation of the at least one attaching element and/or wherein the attachment device comprises at least one positioning member for insertion into at least one shaped element of the support structure for positioning the attachment device relative to the support structure prior to the engagement of at least one attaching element.

7. Assembly system according to claim 1, wherein the support structure is fixedly arranged, preferably fixedly arranged on or inside a cabinet, in particular inside an electric cabinet, wherein the support structure is preferably formed as a shaped profile and/or wherein the shaped elements of the support structure are preferably formed by a hole pattern, wherein the hole pattern preferably comprises slot holes and round holes, which preferably alternate along a hole pattern line, wherein the shaped profile preferably comprises a plurality of hole pattern lines, preferably formed on hole pattern portions being arranged at a distance from each other and/or at an angle relative to each other.

8. Assembly system according to claim 7, wherein the attaching elements are preferably configured to be connected with the long holes and/or the round holes, wherein the engaging members are preferably configured to engage the long holes, wherein the support member and/or the positioning member is preferably configured to be inserted into a round hole.

9. Attachment device for attaching a lamp, in particular for attaching an electric cabinet lamp to an electric cabinet, comprising:
at least two attaching elements for the connection with at least two shaped elements of a support structure for the attachment of a lamp,
wherein at least one of the attaching elements is movable relative to the other attaching element for a tool-free engagement of one of the shaped elements, and
wherein the relative movement between the attaching elements is guided by a guiding structure.

10. Lamp, in particular for the attachment in an electric cabinet, comprising the attachment device according to claim 9.

11. Method for attaching a lamp, in particular for attaching an electric cabinet lamp to an electric cabinet, comprising the steps of:
positioning a lamp with an attachment device adjacent to a support structure,
moving one of the attaching elements of the attachment device relative to another attaching element of the attachment device from a release position into an engaging position for tool-free engaging one of the shaped elements of the support structure.

12. Assembly system according to claim 2, wherein at least one attaching element is movable relative to the other attaching element between an engaging and a release position, wherein the relative movement is preferably limited in both directions, wherein preferably both attaching elements are movable relative to a lamp casing.

13. Assembly system according to claim 2, wherein the attachment device comprises a guiding structure for guiding the relative movement between the attaching elements, wherein the guiding structure is preferably connected to or provided on a lamp casing, wherein the guiding structure preferably comprises at least one guiding groove for guiding at least one attaching element, wherein the guiding structure preferably comprises a plurality of guiding grooves, which are preferably oriented at an angle relative to each other and/or wherein the attaching elements are preferably, detachable from the guiding structure, wherein preferably both attaching elements are movable relative to the guiding structure.

14. Assembly system according to claim 3, wherein the attachment device comprises a guiding structure for guiding the relative movement between the attaching elements, wherein the guiding structure is preferably connected to or provided on a lamp casing, wherein the guiding structure preferably comprises at least one guiding groove for guiding at least one attaching element, wherein the guiding structure preferably comprises a plurality of guiding grooves, which are preferably oriented at an angle relative to each other and/or wherein the attaching elements are preferably detachable from the guiding structure, wherein preferably both attaching elements are movable relative to the guiding structure.

15. Assembly system according to claim 2, wherein the attachment device comprises at least one securing element for forcing at least one attaching element into the engaging position and/or maintaining the attaching element in the engaging position, wherein preferably both attaching elements are forced into and/or maintained in the engaging position by a securing element, wherein the securing element is preferably supported relative to the guiding structure.

16. Assembly system according to claim 3, wherein the attachment device comprises at least one securing element for forcing at least one attaching element into the engaging position and/or maintaining the attaching element in the engaging, position, wherein preferably both attaching elements are forced into and/or maintained in the engaging position by a securing element, wherein the securing element is preferably supported relative to the guiding structure.

17. Assembly system according to claim 4, wherein the attachment device comprises at least one securing element for forcing at least one attaching element into the engaging position and/or maintaining the attaching element in the engaging position, wherein preferably both attaching elements are forced into and/or maintained in the engaging position by a securing element, wherein the securing element is preferably supported relative to the guiding structure.

18. Assembly system according to claim 2, wherein the attachment device comprises at least one support member for insertion into at least one shaped element of the support structure for restricting the movement of the guiding structure at least in a moving orientation of the at least one attaching element and/or wherein the attachment device comprises at least one positioning member for insertion into at least one shaped element of the support structure for positioning the attachment device relative to the support structure prior to the engagement of at least one attaching element.

19. Assembly system according to claim 3, wherein the attachment device comprises at least one support member for insertion into at least one shaped element of the support structure for restricting the movement of the guiding structure at least in a moving orientation of the at least one attaching element and/or wherein the attachment device comprises at least one positioning member for insertion into at least one shaped element of the support structure for positioning the attachment device relative to the support structure prior to the engagement of at least one attaching element.

20. Assembly system according to claim 4, wherein the attachment device comprises at least one support member for insertion into at least one shaped element of the support structure for restricting the movement of the guiding structure at least in a moving orientation of the at least one attaching element and/or wherein the attachment device comprises at least one positioning member for insertion into at least one shaped element of the support structure for positioning the attachment device relative to the support structure prior to the engagement of at least one attaching element.
